(19) United States
(12) Patent Application Publication
(10) Pub. No.: US 2021/0374825 A1
(43) Pub. Date: Dec. 2, 2021

(54) GENERATING RELATIONSHIP DATA FROM LISTING DATA

(71) Applicant: eBay Inc., San Jose, CA (US)

(72) Inventors: Ramesh Periyathambi, San Ramon, CA (US); Kishore Kumar Mohan, Fremont, CA (US); Selcuk Kopru, San Jose, CA (US); Lakshimi Duraivenkatesh, San Ramon, CA (US); Tomer Lancewicki, Jersey City, NJ (US)

(21) Appl. No.: 16/884,392

(22) Filed: May 27, 2020

(51) Int. Cl. G06Q 30/06; G06F 40/40; G06F 16/955

(52) U.S. Cl. CPC G06Q 30/0631; G06F 16/955; G06F 40/40

(57) ABSTRACT

Disclosed are systems, methods, and non-transitory computer-readable media for generating relationship data from listing data. A recommendation system accesses a listing posted to an online marketplace that offers an item for sale. The recommendation system identifies, from listing data included in the listing, a different listing posted to the online marketplace that is offering a recommended item for sale. The listing data is entered by a user that posted the listing to the online marketplace. The recommendation system categorizes the recommended item in a category of items that is related to the item. The recommendation system may generate item recommendation based on the category of items that is related to the item, such as an item recommendation identifying the listing offering the recommended item for sale.

### TECHNICAL FIELD

An embodiment of the present subject matter relates generally to relationship data and, more specifically, to generating relationship data from listing data.

### BACKGROUND

Online marketplace services allow users to buy and sell items. For example, these services enable users to post listings offering items sale, as well as view listings posted by other users. Users of the online marketplace service may submit offers to purchase the listed items, such as by submitting bids during a live auction, offering an amount for the listed item, and/or agreeing to pay a fixed sale price to purchase a listed item. In any case, the online marketplace service facilitates the sale of the listed items between sellers and purchases.

Item recommendations are commonly used to increase the number of sales facilitated by the online marketplace system. For example, a user viewing a listing for an item may be presented with an item recommendation that identifies other items which the user may be interested in purchasing. Currently, the process of generating item recommendations is performed either manually or using recommendation algorithms. Manually generating recommendations involves human reviewers identifying relationships between items and generating data based on the identified relationships. Not only is this process laborious and expensive, but it also provides potentially poor results as the human reviewers review a wide variety items and may not possess adequate expertise in each area. Recommendation algorithms are also problematic as they are often difficult and expensive to build, require large amounts of data, and provide mixed results. Accordingly, improvements are needed.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 shows a system for generating relationship data from listing data, according to some example embodiments.

FIG. 2 is a block diagram of a recommendation system, according to some example embodiments.

FIGS. 3A and 3B show listings posted to an online marketplace, according to some example embodiments.

FIG. 4 is a flowchart showing a method of generating relationship data from listing data, according to certain example embodiments.

FIG. 5 is a flowchart showing a method of generating an item recommendation based on relationship data, according to certain example embodiments.

FIG. 6 is a block diagram illustrating a representative software architecture, which may be used in conjunction with various hardware architectures herein described.

FIG. 7 is a block diagram illustrating components of a machine, according to some example embodiments, able to read instructions from a machine-readable medium (e.g., a machine-readable storage medium) and perform any one or more of the methodologies discussed herein.

### DETAILED DESCRIPTION

In the following description, for purposes of explanation, various details are set forth in order to provide a thorough understanding of some example embodiments. It will be apparent, however, to one skilled in the art, that the present subject matter may be practiced without these specific details, or with slight alterations.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various examples may be given throughout this description. These are merely descriptions of specific embodiments. The scope or meaning of the claims is not limited to the examples given.

Disclosed are systems, methods, and non-transitory computer-readable media for generating relationship data from listing data. The listing data is data included in an item listing posted to an online marketplace. For example, the listing data may be provided by a seller to describe the item listed for sale, such as a listing title, listing description, price, and the like. The listing data may also include data identifying other listings posted to the online marketplace to encourage additional sales of the seller's listed items. For example, a seller may include text and/or images describing the other listings posted by the seller, as well as links (e.g., hyperlinks) that can be used to access the described listings. In many cases, a seller will carefully select the other listings included in an item listing based on the seller's knowledge of the items. For example, a seller may include links to similar items that the seller knows to be substitutes for the listed items, accessory items that the seller knows to be compatible with the listed item or complimentary items that the seller has found to be commonly purchased along with the listed item.

A recommendation system leverages this listing data to generate relationship data describing relationships between various items and/or listings. For example, the relationship data may indicate a set of items that are similar to a target item, a set of items that are complimentary to the target item, and/or a set of items that are accessories to a target item. The relationship data can be used to generate item recommendations to be presented to users of the online marketplace service. For example, a user may be presented with an item recommendation for an item that is similar, complimentary, and/or an accessory of an item that the user is viewing and/or has indicated an interest in purchasing.

To generate the relationship data, the recommendation system analyzes listings posted to the online marketplace to determine whether a seller has included data identifying other listings in the item description. For example, the recommendation system may search the listing data (e.g., item description) for listing identifiers and/or Uniform Resource Locators (URLs) that reference other listings posted to the online marketplace. Inclusion of another listing in the listing data indicates that a relationship exists between the items offered for sale by the listings, such as the listed items being similar, complimentary and/or accessories.

The recommendation system may analyze text included in the listing to determine the type of relationship between the listed items. For example, the recommendation system may use Natural Language Processing (NLP) techniques to determine the relationship between the listed items, such as the items being similar, complimentary and/or accessories. The recommendation system generates relationship data indicating the relationship between the items and/or listings, such as by generating a record that the items are related and including data identifying the type of relationship between the items.

The generated recommendation data may be used to generated item recommendations provided to users of the online marketplace service. For example, a listing for an item may include a set of items recommendations identifying similar, complimentary and/or accessory items. As another example, an item recommendation may be provided to a user based on monitored activity of the user. For example, a user's monitored activity may be used to identify an item that the user has recently viewed and/or purchases, and the relationship data may be used to identify other items to recommend to the user, such as similar, complimentary and/or accessory items.

The functionality of the recommendation system provides several technical improvements. As explained earlier, current recommendation algorithms are complicated systems that are difficult to build, maintain and require large amounts of data to provide reliable results. As such, implementation of these recommendation algorithms is costly and highly resource intensive. The recommendation system alleviates these issues by leveraging the knowledge of the sellers as indicated by the other listings the sellers include in their items descriptions rather than using a recommendation algorithm. As a result, resource usage associated with the generating item relationship data is greatly reduced and the resulting data accuracy is increased as it is based on the expert knowledge of the sellers.

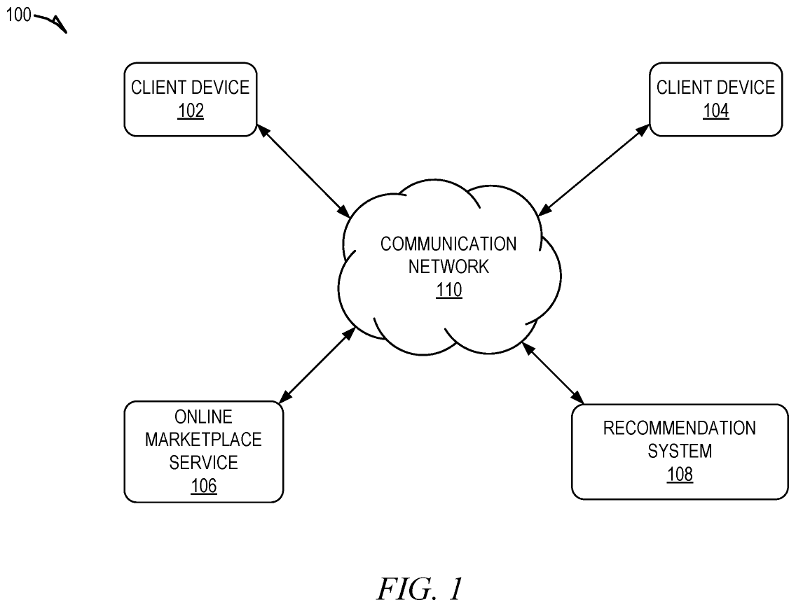

FIG. 1 shows a system 100 for generating relationship data from listing data, according to some example embodiments. As shown, multiple devices (i.e., client device 102, client device 104, online marketplace service 106, and recommendation system 108) are connected to a communication network 110 and configured to communicate with each other through use of the communication network 110. The communication network 110 is any type of network, including a local area network (LAN), such as an intranet, a wide area network (WAN), such as the internet, or any combination thereof. Further, the communication network 110 may be a public network, a private network, or a combination thereof. The communication network 110 is implemented using any number of communication links associated with one or more service providers, including one or more wired communication links, one or more wireless communication links, or any combination thereof. Additionally, the communication network 110 is configured to support the transmission of data formatted using any number of protocols.

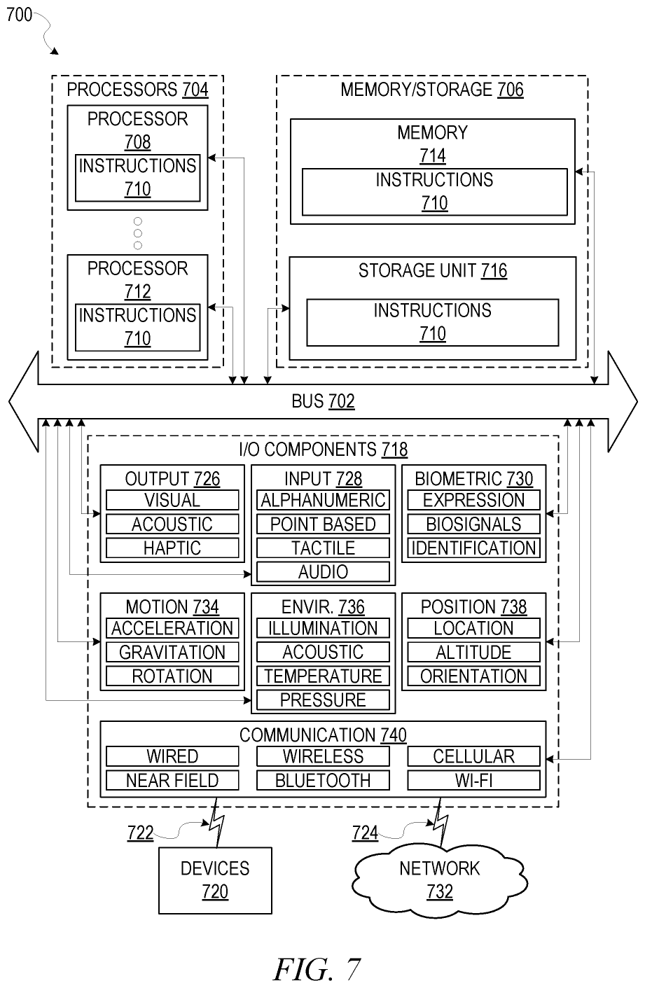

Multiple computing devices can be connected to the communication network 110. A computing device is any type of general computing device capable of network communication with other computing devices. For example, a computing device can be a personal computing device such as a desktop or workstation, a business server, or a portable computing device, such as a laptop, smart phone, or a tablet personal computer (PC). A computing device can include some or all of the features, components, and peripherals of the machine 700 shown in FIG. 7.

To facilitate communication with other computing devices, a computing device includes a communication interface configured to receive a communication, such as a request, data, and the like, from another computing device in network communication with the computing device and pass the communication along to an appropriate module running on the computing device. The communication interface also sends a communication to another computing device in network communication with the computing device.

In the system 100, users interact with the online marketplace service 106 to utilize the services provided by the online marketplace service 106. The online marketplace service 106 provides an online marketplace to which users may post listings offering items for sale, as well as purchase items posted for sale by other users. For example, the online marketplace service 106 may include listings for items being auctioned for sale and/or items listed for sale at a set price. Users communicate with and utilize the functionality of the online marketplace service 106 by using the client devices 102 and 104 that are connected to the communication network 110 by direct and/or indirect communication.

Although the shown system 100 includes only two client devices 102, 104, this is only for ease of explanation and is not meant to be limiting. One skilled in the art would appreciate that the system 100 can include any number of client devices 102, 104. Further, the online marketplace service 106 may concurrently accept connections from and interact with any number of client devices 102, 104. The online marketplace service 106 supports connections from a variety of different types of client devices 102, 104, such as desktop computers; mobile computers; mobile communications devices, e.g., mobile phones, smart phones, tablets; smart televisions; set-top boxes; and/or any other network enabled computing devices. Hence, the client devices 102 and 104 may be of varying type, capabilities, operating systems, and so forth.

A user interacts with the online marketplace service 106 via a client-side application installed on the client devices 102 and 104. In some embodiments, the client-side application includes a component specific to the online marketplace service 106. For example, the component may be a stand-alone application, one or more application plug-ins, and/or a browser extension. However, the users may also interact with the online marketplace service 106 via a third-party application, such as a web browser, that resides on the client devices 102 and 104 and is configured to communicate with the online marketplace service 106. In either case, the client-side application presents a user interface (UI) for the user to interact with the online marketplace service 106. For example, the user interacts with the online marketplace service 106 via a client-side application integrated with the file system or via a webpage displayed using a web browser application.

The online marketplace service 106 is one or more computing devices configured to facilitate an online marketplace (e.g., EBAY, AMAZON, etc.) to which users may post items for sale and purchase items posted for sale by other users. For example, the online marketplace service 106 provides a user interface in which users may view item listings posted to the online marketplace service 106. Each item listing provides details for an item or items listed for sale. For example, the item listing may include an item description, images, sale price, current bid price, auction time remaining, etc.

The online marketplace service 106 may further provide functionality that enables a user to purchase and/or submit on offer to purchase an item. For example, the online marketplace service 106 may provide user interface elements (e.g., buttons, text fields, etc.) that a user may use to purchase an item, submit an offer, etc., as well as provide their financial (e.g., credit card number, bank account number) and personal information (e.g., shipping address, billing address, etc.) to complete the purchase.

To list an item for sale on the online marketplace, a user creates a user account with the online marketplace service 106. The user account may include the user's personal information (e.g., name, address, email address, phone number, etc.) and financial information (e.g., credit card information, bank account information, etc.). Once the user has created a user account, the user may then use their user account to utilize the functionality of the online marketplace service 106, including listing an item for sale on the online marketplace. The online marketplace service 106 provides users with a listing interface that enables a user to create a new listing as well as provide listing data for the listing. The listing data includes data describing the listed item, such as a listing title, item description, sale price, images, and the like. For example, the listing interface may include data fields that prompt the user to provide specified information for the listing, such as the sale price, description, etc. The listing interface may also include user interface elements, such as buttons, that enable the user to submit and/or post a completed listing. That is, the user may post the listing after the user has filled in the data fields included in the listing interface.

Some users (e.g., sellers) may use the item description for one or their listings to promote some of the seller's other item listings. For example, a seller may promote listings for secondary items that the seller believes to be related to the primary item being offered for sale by the listing, and thus may be of interest to the buyer viewing the listing. Examples of secondary items may include items that the seller believes are similar (e.g., alternates) to the primary item, accessories of the primary item, complimentary to the primary item, and the like. Promoting the secondary items in the listing for the primary item may increase the likelihood of sale of the secondary items. To include the secondary items in the item listing, a seller may include a description of the secondary items and/or a link or other data that allows a user to access the listings for the secondary items.

As explained earlier, some current marketplace services attempt to similarly increase sales by providing item recommendations. This process, however, is performed either manually or by using recommendation algorithms, which both have drawback. For example, manually generating recommendations is laborious, expensive, and may provide poor based in the expertise of the human reviewers. Recommendation algorithms are also problematic as they are difficult and expensive to build, require large amounts of data, and provide mixed results. To alleviate these issues, the online marketplace service 106 utilizes the functionality of the recommendation system 108 to generate item recommendations. Although the recommendation system 108 and the online marketplace service 106 are shows as separate devices, this is just one example and it not meant to be limiting. The functionality of the recommendation system 108 may be incorporated, partially or completely, within the online marketplace service 106.

The recommendation system 108 leverages the expertise of sellers to generate item recommendations. Some sellers may promote secondary items in their listings by including text and/or images describing the secondary items listed by the seller, as well as including links (e.g., hyperlinks) that can be used to access the listings. In many cases, a seller will carefully select the secondary items to promote in an item listing based on the seller's knowledge of the items. For example, a seller may include links to accessory items that the seller knows to be compatible with the listed item or complimentary items that the seller has found to be commonly purchased along with the listed item.

The recommendation system 108 leverages this seller provided listing data to generate relationship data describing relationships between various items and/or listings. For example, the relationship data may indicate a set of secondary items that are similar to a primary item, complimentary to the primary item, and/or are accessories to the primary item. The relationship data can be used to generate item recommendations to be presented to users of the online marketplace. For example, a user may be presented with an item recommendation for an item that is similar, complimentary, and/or an accessory of an item that the user is viewing and/or has indicated an interest in purchasing.

To generate the relationship data, the recommendation system 108 analyzes item listings posted to the online marketplace to determine whether a seller has included data identifying other item listings in the item description. The other item listings may offer secondary items that are related to the primary item being offered for sale by the listing in which the other item listings are included. For example, the recommendation system 108 may search the listing data (e.g., item description) for listing identifiers and/or Uniform Resource Locators (URLs) that reference other listings posted to the online marketplace. Inclusion of another listing in the listing data indicates that a relationship exists between the items offered for sale by the listings, such as the listed items being similar, complimentary and/or accessories.

The recommendation system 108 may analyze text included in the listing data to determine the type of relationship between the listed items. For example, the recommendation system 108 may use Natural Language Processing (NLP) techniques to determine the relationship between the listed items, such as the items being similar, complimentary and/or accessories. The recommendation system 108 generates relationship data indicating the relationship between the items and/or listings, such as by generating a record that the items are related and including data identifying the type of relationship between the items.

The recommendation system 108 may use the generated recommendation data to generate item recommendations provided to users of the online marketplace. For example, a listing for an item may include a set of items recommendations identifying secondary items that are similar, complimentary and/or accessory items. As another example, an item recommendation may be provided to a user based on monitored activity of the user. For example, a user's monitored activity may be used to identify an item that the user has recently viewed and/or purchases, and the relationship data may be used to identify secondary items to recommend to the user, such as similar, complimentary and/or accessory items.

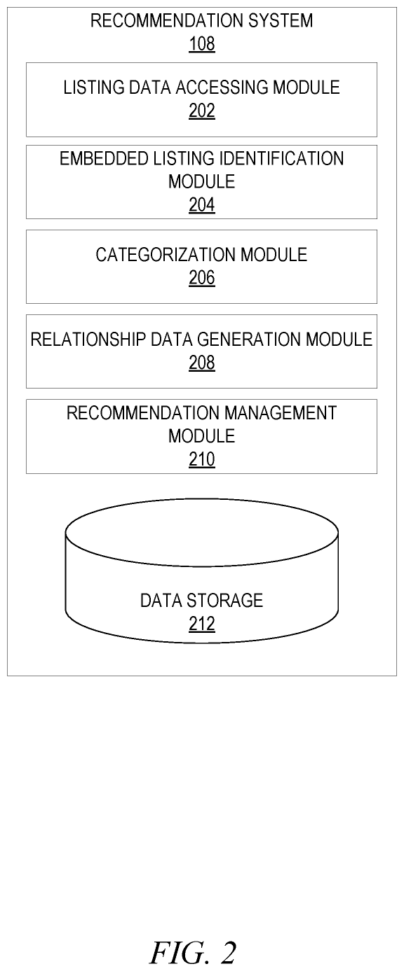

FIG. 2 is a block diagram of a recommendation system 108, according to some example embodiments. To avoid obscuring the inventive subject matter with unnecessary detail, various functional components (e.g., modules) that are not germane to conveying an understanding of the inventive subject matter have been omitted from FIG. 2. However, a skilled artisan will readily recognize that various additional functional components may be supported by the recommendation system 108 to facilitate additional functionality that is not specifically described herein. Furthermore, the various functional modules depicted in FIG. 2 may reside on a single computing device or may be distributed across several computing devices in various arrangements such as those used in cloud-based architectures. For example, the various functional modules and components may be distributed amongst computing devices that facilitate both the recommendation system 108 and the online marketplace service 106.

As shown, the recommendation system 108 includes a listing data accessing module 202, an embedded listing identification module 204, a categorization module 206, relationship data generation module 208, a recommendation management module 210, and a data storage 212.

The listing data accessing module 202 accesses listing data for item listings posted to the online marketplace. The listing data for each item listing includes data describing an item (e.g., primary item) listed for sale to the online marketplace. For example, the listing data may include a listing title, sale price, item description, images, and the like. The listing data may be provided by a seller of the item when generating the item listing.

The listing data accessing module 202 may access the listing data from the online marketplace service 106 and/or the data storage 212. For example, the listing data accessing module 202 may periodically transmit request to the online marketplace service 106 for listing data, which the online marketplace service 106 may return in response. The listing data accessing module 202 may also access the listing data from the data storage 212, such as in embodiments in which the recommendation system 108 is incorporated as part of the online marketplace service 106. In either case, the listing data accessing module 202 may periodically access listing data for listings posted to the online marketplace. This may include accessing listing data for listings offering a specified type or category of items, listings posted within a specified time frame, and the like. The listing data gathered by the listing data accessing module 202 can be used to generate relationship data for generating item recommendations.

The embedded listing identification module 204 analyzes the gathered listing data for a primary item to identify listings for secondary items that have been included in the listing data. For example, a seller may promote secondary items being offered for sale by the seller by including a description and/or link to the listings for the secondary items in the item description of the listing for the primary item. The embedded listing identification module 204 identifies the other listings by searching the listing data (e.g., item description) for characters or sets of characters that indicate that a reference to another item listing is included in the listing data. For example, the embedded listing identification module 204 may search the listing data for listing identifiers and/or URLs that reference other listings posted to the online marketplace.

The categorization module 206 categorizes the relationship between a primary and secondary item. Inclusion of another listing in the listing data indicates that a relationship exists between the primary item offered for sale by the listing and the secondary item offered for sale by the listings included in the listing data, such as the listed items being similar, complimentary and/or accessories. The categorization module 206 determines the type of relationship that exists between a primary and secondary item. The determined categorization is used to enrich the relationship data, which allows for higher quality item recommendations.

The categorization module 206 may determine the type of categorization based on an analysis of the text included in the item description. For example, the categorization module 206 may use NLP techniques to analyze the text to determine the categorization. In some embodiments, the categorization module 206 may search the text for specified terms (e.g., words) that are located near the reference to the other listing in the listing that may indicate the type of relationship between the items. For example, terms such as “similar” or “you may also consider” that are located in the item description before an identified URL to another listing may indicate that the listing offers a secondary item that is similar to the primary listing. As another example, terms such as “compatible” or “works well with” that are located in the item description before an identified URL to another listing may indicate that the listing offers a secondary item that is accessory to the primary listing. As another example, term such as “goes well with” or “often purchased with” that are located in the item description before an identified URL to another listing may indicate that the listing offers a secondary item that is complementary to the primary listing.

In some embodiments, the categorization module 206 may use a machine learning model to determine the categorization. For example, the categorization module 206 may use labeled training data, such as listing data promoting secondary item have been manually labeled with a categorization to train a machine learning model, such as a text classification model. The trained text classification model assigns probability values to a set of classifiers corresponding to each possible category. Each probability value indicates a likelihood that the category corresponding to the classifier properly categorizes the relationship between the primary and secondary items. The categorization module 206 may use the listing data or a subset of the listing data as input into the trained text classification model and select the proper category based on the resulting probability values. For example, the categorization module 206 may select the category that has the highest probability value.

In some embodiments, the machine learning model may be trained based on vector representation of the listing data. For example, the categorization module 206 may generate a vector representation based on a set of selected features extracted from the labeled training data. In this type of embodiment, the categorization module 206 uses a similar technique to generate a vector representation of a listing, which the categorization module 206 then uses as input into the trained machine learning model.

Although the example categories of similar, complimentary and accessory are used, this is just one example and is not meant to be limiting. The categorization module 206 may use the described functionality to categorize the relationship between the primary and secondary items into any number of categories.

The relationship data generation module 208 generates relationship data based on the outputs of the embedded listing identification module 204 and the categorization module 206. The relationship data indicates relationships between items and/or listings. For example, the relationship data may include a relationship index that identifies the related items and/or listings, as well as includes data identifying the determined relationships between them, such as an indicator representing the category (e.g., similar, complimentary and/or accessory) determined by the categorization module 206.

The relationship data generation module 208 may generate the relationship data by creating new records or entries in the relationship index based on a newly determined relationship and/or by updating existing records or entries in the relationship index. For example, the relationship data generation module 208 may update an existing record to increment that an additional occurrence of the relationship was detected from listing data, such as by incrementing a counter associated with the record. Updating the relationship data in this manner may provide data used for evaluating a strength of the relationship between items. For example, a relationship with a relatively higher number of occurrences may indicate a stronger relationship between the items and/or listings.

The relationship data can be stored in the data storage 212. Accordingly, the relationship data generation module 208 may communicate with the data storage 212 to generate the relationship data, such as by generating new entries in the relationship index and/or updating existing entries in the relationship index.

The recommendation management module 210 generates item recommendations based on the relationship data and presents the item recommendations to users of the online marketplace. An item recommendation identifies items posted for sale on the online marketplace that a user may be interested in purchasing. For example, an item recommendation may include a description of the item and a link to a listing offering the item for sale.

The recommendation management module 210 may generate item recommendations for a user based on an item that is determined to be of interest to the user. For example, the recommendation management module 210 may generate an item recommendation based on an item that the user is viewing, has searched for, has indicated that is of interest to the user, has recently purchased, and the like.

The item recommendations generated by the recommendation management module 210 may recommend items that are related to the item of interest to the user. For example, the item recommendations may identify similar items that the user may also be interested in as a substitute to the item of interest. As another example, the item recommendations may identify items that are accessories or complimentary to the item of interest.

The recommendation management module 210 generates the item recommendations based on the relationship data stored in the data storage 212. For example, the recommendation management module 210 searches the relationship index for an entry associated with the item of interest to the user. The recommendation management module 210 may identify related items based on the identified entry and select one or more of the related items to be provided as item recommendations to the user.

The recommendation management module 210 may select from the related items in any of a variety of ways, such as by selecting items based on the strength of relationship between the items, whether there are active listings for the item posted to the online marketplace, the type of relationship between the items, and the like. For example, the recommendation management module 210 may select an item and/or an item from each category that has the strongest relationship with the item of interest. As another example, the recommendation management module 210 may select items from a category based on whether the user has purchased an item of interest. For example, the recommendation management module 210 may select items that are categorized as accessories or complimentary when a user has purchased the item of interest. Alternatively, the recommendation management module 210 may select items that are categorized as similar when a user has not yet purchased the item of interest.

The recommendation management module 210 may present the item recommendations to a user in any of a variety of ways, such as within a user interface as the user is utilizing the functionality of the online marketplace service 106, as a message provided to the user via a different channel (e.g., email, text, chat), and the like.

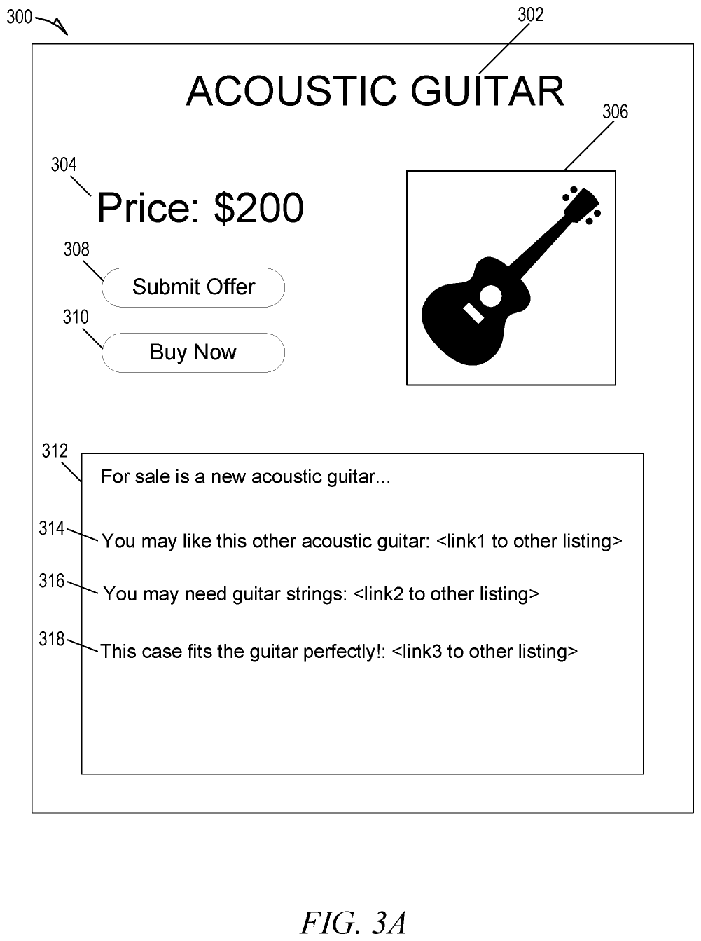

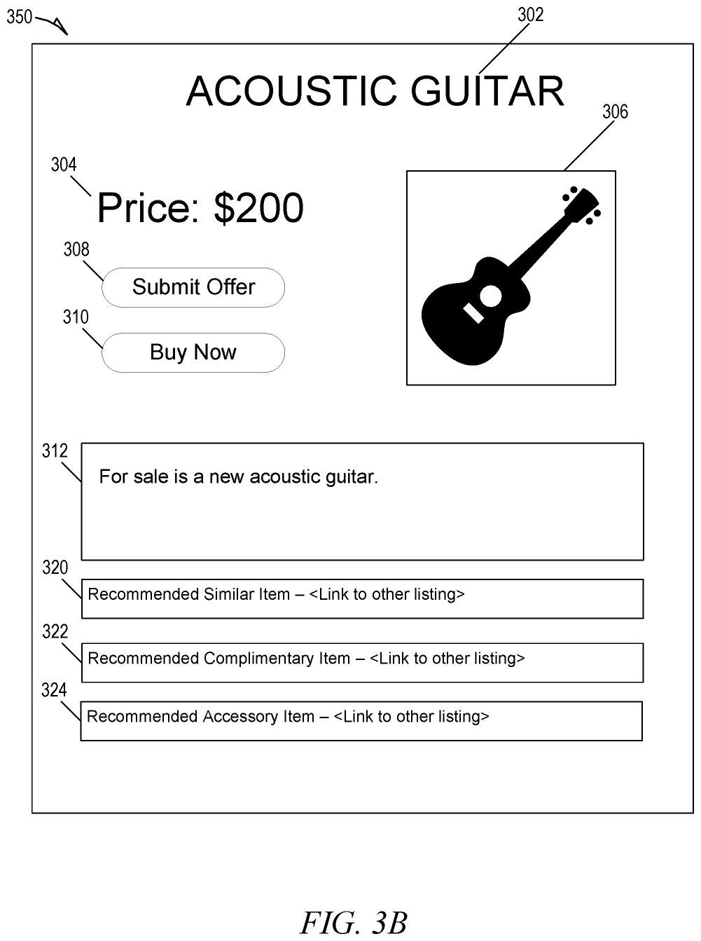

FIGS. 3A and 3B show listings posted to an online marketplace, according to some example embodiments. FIG. 3A shows a listing 300 including seller provided item recommendations. As show, the listing 300 includes a listing title 302, a listing price 304, a listing image 306, a submit offer button 308, a buy now button 310, and an item description 312. The listing title 302 provides a descriptive title for the listing 300 that indicates that the listing 300 is offering an acoustic guitar for sale. The listing price 304 indicates a monetary amount of $200 at which the listed acoustic guitar is being offered for purchase. The listing image 306 provides an image of the acoustic guitar listed for sale. The submit offer button 308 enables a user to submit an offer to purchase the guitar for price specified by the user. For example, a user may submit an offer to purchase the acoustic guitar for an amount that is below the listing price 304 of $200, which the seller may approve or deny. The buy now button 310 enables a user to purchase the listed acoustic guitar for the listing price 304 of $200. The item description 312 provides a description of the listed acoustic guitar. The item description 312 is provided (e.g., entered) by a seller when generating the listing 300.

As shown, the item description 312 promotes other listings posted to the online marketplace. For example, the item description 312 includes a first seller recommendation 314 for another acoustic guitar. The first seller recommendation 314 includes text indicating that the user may like this acoustic guitar. The text included in the first seller recommendation 314 may be used to derive that the other listed guitar is similar and/or considered as a substitute to the acoustic guitar being offered by the listing 300. The first seller recommendation 314 also includes a link that enables a user to navigate to the other listing. For example, a user may select the link to be navigated to the listing for the other acoustic guitar.

The item description 312 includes a second seller recommendation 316 for guitar strings. The second seller recommendation 316 includes text stating that the user may need guitar strings to go along with the listed acoustic guitar. The text included in the second seller recommendation 316 may be used to derive that the guitar strings are a complimentary to the acoustic guitar being offered by the listing 300. The second seller recommendation 316 also includes a link that enables a user to navigate to the other listing. For example, a user may select the link to be navigated to the listing for the guitar strings.

The item description 312 includes a third seller recommendation 318 for a guitar case. The third seller recommendation 318 includes text stating that the case fits the listed acoustic guitar. The text included in the third seller recommendation 318 may be used to derive that the guitar case is an accessory (e.g., compatible) to the acoustic guitar being offered by the listing 300. The third seller recommendation 318 also includes a link that enables a user to navigate to the other listing. For example, a user may select the link to be navigated to the listing for the guitar case.

FIG. 3B shows a listing 350 including item recommendations generated by the recommendation system 108. As shown, the listing 350 is similar to the listing 300 shown in FIG. 3A in that it includes a listing title 302, a listing price 304, a listing image 306, a submit offer button 308, a buy now button 310, and an item description 312. However, the listing 350 shown in FIG. 3B differs from the listing 300 shown in FIG. 3A in that it does not include seller provided item recommendations in the item description 312 and instead includes item recommendations 320, 322, 324 generated by the recommendation system 108.

The listing 350 includes a first item recommendation 320 that recommends a similar item as the acoustic guitar being offered by the listing 350. The first item recommendation 320 includes a link to a listing for the similar item.

The listing 350 includes a second item recommendation 322 that recommends a complimentary item to the acoustic guitar being offered by the listing 350. The second item recommendation 322 includes a link to a listing for the accessory item.

The listing 350 includes a third item recommendation 324 that recommends an accessory item to the acoustic guitar being offered by the listing 350. The third item recommendation 324 includes a link to a listing for the complimentary item.

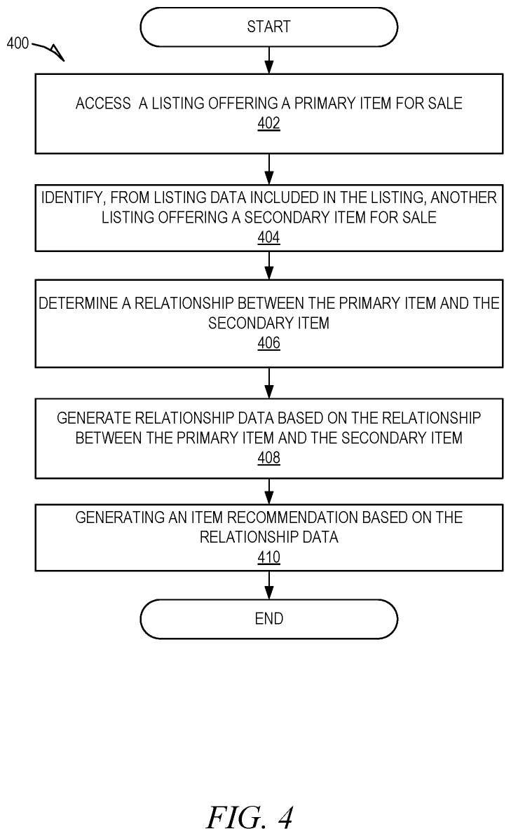

FIG. 4 is a flowchart showing a method 400 of generating relationship data from listing data, according to certain example embodiments. The method 400 may be embodied in computer readable instructions for execution by one or more processors such that the operations of the method 400 may be performed in part or in whole by the recommendation system 108; accordingly, the method 400 is described below by way of example with reference thereto. However, it shall be appreciated that at least some of the operations of the method 400 may be deployed on various other hardware configurations and the method 400 is not intended to be limited to the recommendation system 108.

At operation 402, the listing data accessing module 202 accesses a listing offering a primary item for sale. The listing data accessing module 202 accesses listing data for item listings posted to the online marketplace. The listing data for each item listing includes data describing an item (e.g., primary item) listed for sale to the online marketplace. For example, the listing data may include a listing title, sale price, item description, images, and the like. The listing data may be provided by a seller of the item when generating the item listing.

The listing data accessing module 202 may access the listing data from the online marketplace service 106 and/or the data storage 212. For example, the listing data accessing module 202 may periodically transmit request to the online marketplace service 106 for listing data, which the online marketplace service 106 may return in response. The listing data accessing module 202 may also access the listing data from the data storage 212, such as in embodiments in which the recommendation system 108 is incorporated as part of the online marketplace service 106. In either case, the listing data accessing module 202 may periodically access listing data for listings posted to the online marketplace. This may include accessing listing data for listings offering a specified type or category of items, listings posted within a specified time frame, and the like. The listing data gathered by the listing data accessing module 202 can be used to generate relationship data for generating item recommendations.

At operation 404, the embedded listing identification module 204 identifies, from listing data included in the listing, another listing offering a secondary item for sale. The embedded listing identification module 204 analyzes the gathered listing data for a primary item to identify listings for secondary items that have been included in the listing data. For example, a seller may promote secondary items being offered for sale by the seller by including a description and/or link to the listings for the secondary items in the item description of the listing for the primary item. The embedded listing identification module 204 identifies the other listings by searching the listing data (e.g., item description) for characters or sets of characters that indicate that a reference to another item listing is included in the listing data. For example, the embedded listing identification module 204 may search the listing data for listing identifiers and/or URLs that reference other listings posted to the online marketplace.

At operation 406, the categorization module 206 determines a relationship between the primary item and secondary item. Inclusion of another listing in the listing data indicates that a relationship exists between the primary item offered for sale by the listing and the secondary item offered for sale by the listings included in the listing data, such as the listed items being similar, complimentary and/or accessories. The categorization module 206 determines the type of relationship that exists between a primary and secondary item. The determined categorization is used to enrich the relationship data, which allows for higher quality item recommendations.

The categorization module 206 may determine the type of categorization based on an analysis of the text included in the item description. For example, the categorization module 206 may use NLP techniques to analyze the text to determine the categorization. In some embodiments, the categorization module 206 may search the text for specified terms (e.g., words) that are located near the reference to the other listing in the listing that may indicate the type of relationship between the items. For example, terms such as “similar” or “you may also consider” that are located in the item description before an identified URL to another listing may indicate that the listing offers a secondary item that is similar to the primary listing. As another example, terms such as “compatible” or “works with” that are located in the item description before an identified URL to another listing may indicate that the listing offers a secondary item that is accessory to the primary listing. As another example, term such as “goes well with” or “often purchased with” that are located in the item description before an identified URL to another listing may indicate that the listing offers a secondary item that is complementary to the primary listing.

In some embodiments, the categorization module 206 may use a machine learning model to determine the categorization. For example, the categorization module 206 may use labeled training data, such as listing data promoting secondary item have been manually labeled with a categorization to train a machine learning model, such as a text classification model. The trained text classification model assigns probability values to a set of classifiers corresponding to each possible category. Each probability value indicates a likelihood that the category corresponding to the classified properly categorizes the relationship between the primary and secondary items. The categorization module 206 may use the listing data or a subset of the listing data as input into the trained text classification model and select the proper category based on the resulting probability values. For example, the categorization module 206 may select the category that has the highest probability value.

In some embodiments, the machine learning model may be trained based on vector representation of the listing data. For example, the categorization module 206 may generate a vector representation based on a set of selected features extracted from the labeled training data. In this type of embodiment, the categorization module 206 uses a similar technique to generate a vector representation of a listing, which the categorization module 206 then uses as input into the trained machine learning model.

At operation 408, the relationship data generation module 208 generates relationship data based on the relationship between the primary item and secondary item. The relationship data generation module 208 generates relationship data based on the outputs of the embedded listing identification module 204 and the categorization module 206. The relationship data indicates relationships between items and/or listings. For example, the relationship data may include a relationship index that identifies the related items and/or listings, as well as includes data identifying the determined relationships between them, such as an indicator representing the category (e.g., similar, complimentary and/or accessory) determined by the categorization module 206.

The relationship data generation module 208 may generate the relationship data by creating new records or entries in the relationship index based on a newly determined relationship and/or by updating existing records or entries in the relationship index. For example, the relationship data generation module 208 may update an existing record to increment that an additional occurrence of the relationship was detected from listing data, such as by incrementing a counter associated with the record. Updating the relationship data in this manner may provide data used for evaluating a strength of the relationship between items. For example, a relationship with a relatively higher number of occurrences may indicate a stronger relationship between the items and/or listings.

The relationship data can be stored in the data storage 212. Accordingly, the relationship data generation module 208 may communicate with the data storage 212 to generate the relationship data, such as by generating new entries in the relationship index and/or updating existing entries in the relationship index.

At operation 410, the recommendation management module 210 generates an item recommendation based on the relationship data. The recommendation management module 210 may generate item recommendations for a user based on an item that is determined to be of interest to the user. For example, the recommendation management module 210 may generate an item recommendation based on an item that the user is viewing, has searched for, has indicated that is of interest to the user, has recently purchased, and the like.

The item recommendations generated by the recommendation management module 210 may recommend items that are related to the item of interest to the user. For example, the item recommendations may identify similar items that the user may also be interested in as a substitute to the item of interest. As another example, the item recommendations may identify items that are accessories or complimentary to the item of interest. In any case, the recommendation management module 210 generates the item recommendations based on the relationship data stored in the data storage 212.

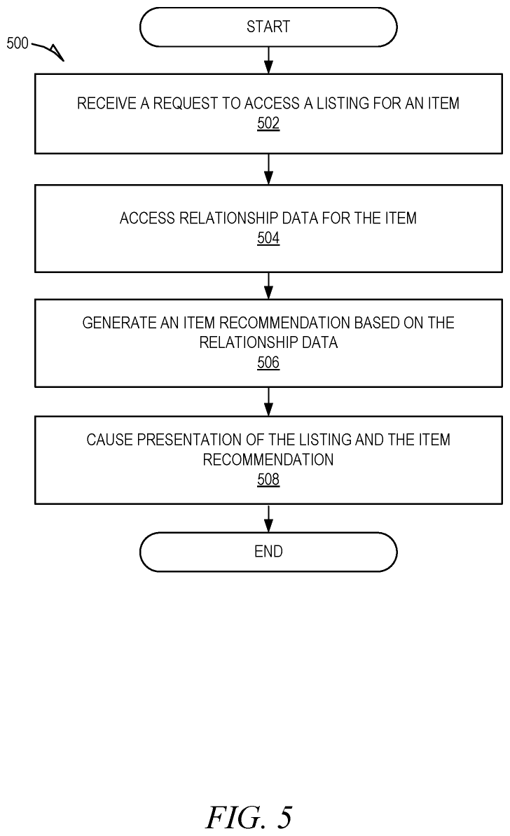

FIG. 5 is a flowchart showing a method 500 of automatically generating an offer for an alternate item, according to certain example embodiments. The method 500 may be embodied in computer readable instructions for execution by one or more processors such that the operations of the method 500 may be performed in part or in whole by the recommendation system 108; accordingly, the method 500 is described below by way of example with reference thereto. However, it shall be appreciated that at least some of the operations of the method 500 may be deployed on various other hardware configurations and the method 500 is not intended to be limited to the recommendation system 108.

At operation 502, the online marketplace service 106 receives a request to access a listing for an item. For example, the request may be received as a result of a user selecting to view the listing.

At operation 504, the recommendation management module 210 accesses relationship data for the item. For example, the recommendation management module 210 searches the relationship index for an entry associated with the item listed by the listing. The recommendation management module 210 may identify related items based on the identified entry and select one or more of the related items to be provided as item recommendations to the user.

At operation 506, the recommendation management module 210 generates an item recommendation based on the relationship data. The recommendation management module 210 generates the item recommendations based on the relationship data gathered from data storage 212. For example, the recommendation management module 210 may user the relationship data to identify a related item to include in the item recommendation.

The recommendation management module 210 may select from the related items in any of a variety of ways, such as by selecting items based on the strength of relationship between the items, whether there are active listings for the item posted to the online marketplace, the type of relationship between the items, and the like. For example, the recommendation management module 210 may select an item and/or an item from each category that has the strongest relationship with the item of interest. As another example, the recommendation management module 210 may select items from a category based on whether the user has purchased an item of interest. For example, the recommendation management module 210 may select items that are categorized as accessories or complimentary when a user has purchased the item of interest. Alternatively, the recommendation management module 210 may select items that are categorized as similar when a user has not yet purchased the item of interest.

At operation 508, the recommendation management module 210 causes presentation of the listing and the item recommendation. The recommendation management module 210 may present the item recommendations to a user in any of a variety of ways, such as within a user interface as the user is utilizing the functionality of the online marketplace service 106, as a message provided to the user via a different channel (e.g., email, text, chat), and the like.

### Software Architecture

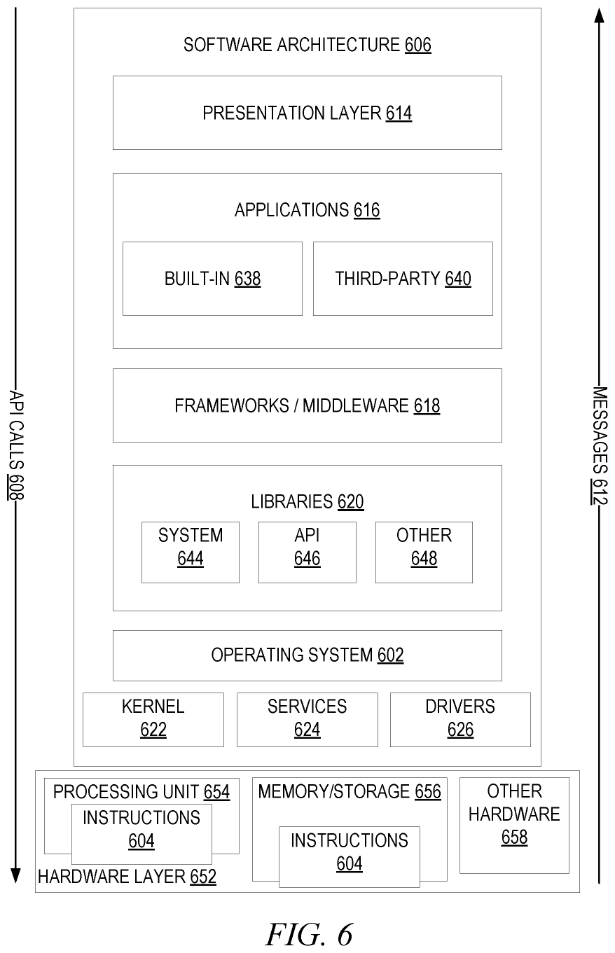

FIG. 6 is a block diagram illustrating an example software architecture 606, which may be used in conjunction with various hardware architectures herein described. FIG. 6 is a non-limiting example of a software architecture 606 and it will be appreciated that many other architectures may be implemented to facilitate the functionality described herein. The software architecture 606 may execute on hardware such as machine 700 of FIG. 7 that includes, among other things, processors 704, memory 714, and (input/output) I/O components 718. A representative hardware layer 652 is illustrated and can represent, for example, the machine 700 of FIG. 7. The representative hardware layer 652 includes a processing unit 654 having associated executable instructions 604. Executable instructions 604 represent the executable instructions of the software architecture 606, including implementation of the methods, components, and so forth described herein. The hardware layer 652 also includes memory and/or storage modules 656, which also have executable instructions 604. The hardware layer 652 may also comprise other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616, and a presentation layer 614. Operationally, the applications 616 and/or other components within the layers may invoke Application Programming Interface (API) calls 608 through the software stack and receive a response such as messages 612 in response to the API calls 608. The layers illustrated are representative in nature and not all software architectures have all layers. For example, some mobile or special purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

The libraries 620 provide a common infrastructure that is used by the applications 616 and/or other components and/or layers. The libraries 620 provide functionality that allows other software components to perform tasks in an easier fashion than to interface directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 620 may also include a wide variety of other libraries 648 to provide many other APIs to the applications 616 and other software components/modules.

The frameworks/middleware 618 (also sometimes referred to as middleware) provide a higher-level common infrastructure that may be used by the applications 616 and/or other software components/modules. For example, the frameworks/middleware 618 may provide various graphical user interface (GUI) functions, high-level resource management, high-level location services, and so forth. The frameworks/middleware 618 may provide a broad spectrum of other APIs that may be used by the applications 616 and/or other software components/modules, some of which may be specific to a particular operating system 602 or platform.

The applications 616 include built-in applications 638 and/or third-party applications 640. Examples of representative built-in applications 638 may include, but are not limited to, a contacts application, a browser application, a book reader application, a location application, a media application, a messaging application, and/or a game application. Third-party applications 640 may include an application developed using the ANDROID™ or IOS™ software development kit (SDK) by an entity other than the vendor of the particular platform, and may be mobile software running on a mobile operating system such as IOS™, ANDROID™, WINDOWS® Phone, or other mobile operating systems. The third-party applications 640 may invoke the API calls 608 provided by the mobile operating system (such as operating system 602) to facilitate functionality described herein.

The applications 616 may use built in operating system functions (e.g., kernel 622, services 624, and/or drivers 626), libraries 620, and frameworks/middleware 618 to create UIs to interact with users of the system. Alternatively, or additionally, in some systems, interactions with a user may occur through a presentation layer, such as presentation layer 614. In these systems, the application/component “logic” can be separated from the aspects of the application/component that interact with a user.

FIG. 7 is a block diagram illustrating components of a machine 700, according to some example embodiments, able to read instructions 604 from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine 700 capable of executing the instructions 710, sequentially or otherwise, that specify actions to be taken by machine 700. Further, while only a single machine 700 is illustrated, the term “machine” shall also be taken to include a collection of machines that individually or jointly execute the instructions 710 to perform any one or more of the methodologies discussed herein.

The machine 700 may include processors 704, memory/storage 706, and I/O components 718, which may be configured to communicate with each other such as via a bus 702. The memory/storage 706 may include a memory 714, such as a main memory, or other memory storage, and a storage unit 716, both accessible to the processors 704 (e.g., processors 708, 712) such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of processors 704 are examples of machine-readable media.

The I/O components 718 may include a wide variety of components to receive input, provide output, produce output, transmit information, exchange information, capture measurements, and so on. The specific I/O components 718 that are included in a particular machine 700 will depend on the type of machine. For example, portable machines such as mobile phones will likely include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion and the grouping is in no way limiting. In various example embodiments, the I/O components 718 may include output components 726 and input components 728. The output components 726 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environmental components 736, or position components 738 among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 734 may include acceleration sensor components (e.g., accelerometer), gravitation sensor components, rotation sensor components (e.g., gyroscope), and so forth. The environmental components 736 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 738 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via coupling 724 and coupling 722, respectively. For example, the communication components 740 may include a network interface component or other suitable device to interface with the network 732. In further examples, communication components 740 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as, location via Internet Protocol (IP) geo-location, location via Wi-Fi® signal triangulation, location via detecting a NFC beacon signal that may indicate a particular location, and so forth.

### Glossary

“CARRIER SIGNAL” in this context refers to any intangible medium that is capable of storing, encoding, or carrying instructions 710 for execution by the machine 700, and includes digital or analog communications signals or other intangible medium to facilitate communication of such instructions 710. Instructions 710 may be transmitted or received over the network 732 using a transmission medium via a network interface device and using any one of a number of well-known transfer protocols.

“CLIENT DEVICE” in this context refers to any machine 700 that interfaces to a communications network 732 to obtain resources from one or more server systems or other client devices. A client device 102, 104 may be, but is not limited to, mobile phones, desktop computers, laptops, PDAs, smart phones, tablets, ultra books, netbooks, laptops, multi-processor systems, microprocessor-based or programmable consumer electronics, game consoles, STBs, or any other communication device that a user may use to access a network 732.

“COMMUNICATIONS NETWORK” in this context refers to one or more portions of a network 732 that may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 732 or a portion of a network 732 may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions 710 and data temporarily or permanently and may include, but is not be limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store instructions 710. The term “machine-readable medium” shall also be taken to include any medium, or combination of multiple media, that is capable of storing instructions 710 (e.g., code) for execution by a machine 700, such that the instructions 710, when executed by one or more processors 704 of the machine 700, cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a computer processor or a group of computer processors 704) may be configured by software (e.g., an application 616 or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor 704 or other programmable processor 704. Once configured by such software, hardware components become specific machines 700 (or specific components of a machine 700) uniquely tailored to perform the configured functions and are no longer general-purpose processors 704. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor 704 (e.g., computer processor) configured by software to become a special-purpose processor, the general-purpose processor 704 may be configured as respectively different special-purpose processors (e.g., comprising different hardware components) at different times. Software accordingly configures a particular processor or processors 704, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses 702) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors 704 that are temporarily configured (e.g., by software) or permanently configured to perform the relevant operations. Whether temporarily or permanently configured, such processors 704 may constitute processor-implemented components that operate to perform one or more operations or functions described herein. As used herein, “processor-implemented component” refers to a hardware component implemented using one or more processors 704. Similarly, the methods described herein may be at least partially processor-implemented, with a particular processor or processors 704 being an example of hardware. For example, at least some of the operations of a method may be performed by one or more processors 704 or processor-implemented components. Moreover, the one or more processors 704 may also operate to support performance of the relevant operations in a “cloud computing” environment or as a “software as a service” (SaaS). For example, at least some of the operations may be performed by a group of computers (as examples of machines 700 including processors 704), with these operations being accessible via a network 732 (e.g., the Internet) and via one or more appropriate interfaces (e.g., an API). The performance of certain of the operations may be distributed among the processors 704, not only residing within a single machine 700, but deployed across a number of machines 700. In some example embodiments, the processors 704 or processor-implemented components may be located in a single geographic location (e.g., within a home environment, an office environment, or a server farm). In other example embodiments, the processors 704 or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands,” “op codes,” “machine code,” etc.) and which produces corresponding output signals that are applied to operate a machine 700. A processor 704 may be, for example, a central processing unit (CPU), a reduced instruction set computing (RISC) processor, a complex instruction set computing (CISC) processor, a graphics processing unit (GPU), a digital signal processor (DSP), an ASIC, a radio-frequency integrated circuit (RFIC) or any combination thereof. A processor may further be a multi-core processor having two or more independent processors 704 (sometimes referred to as “cores”) that may execute instructions 710 contemporaneously.

What is claimed is:

1. A method comprising:
accessing a first listing posted to an online marketplace, the first listing offering a first item for sale;
identifying, from listing data included in the first listing, a second listing posted to the online marketplace, the second listing offering a second item for sale, the listing data having been entered by a user that posted the first listing;
categorizing the second item in a first category of items that is related to the first item; and
generating an item recommendation based on the first category of items that is related to the first item, the item recommendation identifying a third listing offering the second item for sale.

2. The method of claim 1, further comprising:
determining, based on natural language processing of the listing data, that the second item is in the first category of items that is related to the first item.

3. The method of claim 1, wherein identifying the second listing posted to the online marketplace comprises:
identifying a listing identifier for the second listing in the listing data included in the first listing.

4. The method of claim 1, wherein identifying the second listing posted to the online marketplace comprises:
identifying a uniform resource identifier (URL) for the second listing in the listing data included in the first listing.

5. The method of claim 1, wherein the first category of items that is related to the first item includes one of complimentary items, accessory items, and similar items.

6. The method of claim 1, further comprising:
identifying, from the listing data included in the first listing, a fourth listing posted to the online marketplace, the fourth listing offering a third item for sale;
categorizing the third item in a second category of items that is related to the first item; and
generating a second item recommendation based on the second category of items that is related to the first item, the second item recommendation identifying a fifth listing offering the third item for sale.

7. The method of claim 1, wherein the third listing is the second listing.

8. A system comprising:
one or more computer processors; and
one or more computer-readable mediums storing instructions that, when executed by the one or more computer processors, cause the system to perform operations comprising:
accessing a first listing posted to an online marketplace, the first listing offering a first item for sale;
identifying, from listing data included in the first listing, a second listing posted to the online marketplace, the second listing offering a second item for sale, the listing data having been entered by a user that posted the first listing;
categorizing the second item in a first category of items that is related to the first item; and
generating an item recommendation based on the first category of items that is related to the first item, the item recommendation identifying a third listing offering the second item for sale.

9. The system of claim 8, the operations further comprising:
determining, based on natural language processing of the listing data, that the second item is in the first category of items that is related to the first item.

10. The system of claim 8, wherein identifying the second listing posted to the online marketplace comprises:
identifying a listing identifier for the second listing in the listing data included in the first listing.

11. The system of claim 8, wherein identifying the second listing posted to the online marketplace comprises:
identifying a uniform resource identifier (URL) for the second listing in the listing data included in the first listing.

12. The system of claim 8, wherein the first category of items that is related to the first item includes one of complimentary items, accessory items, and similar items.

13. The system of claim 8, the operations further comprising:
identifying, from the listing data included in the first listing, a fourth listing posted to the online marketplace, the fourth listing offering a third item for sale;
categorizing the third item in a second category of items that is related to the first item; and
generating a second item recommendation based on the second category of items that is related to the first item, the second item recommendation identifying a fifth listing offering the third item for sale.

14. The system of claim 8, wherein the third listing is the second listing.

15. A machine-readable medium storing instructions that, when executed by one or more computer processors of one or more computing devices, cause the one or more computing devices to perform operations comprising:
accessing a first listing posted to an online marketplace, the first listing offering a first item for sale;
identifying, from listing data included in the first listing, a second listing posted to the online marketplace, the second listing offering a second item for sale, the listing data having been entered by a user that posted the first listing;
categorizing the second item in a first category of items that is related to the first item; and
generating an item recommendation based on the first category of items that is related to the first item, the item recommendation identifying a third listing offering the second item for sale.

16. The machine-readable medium of claim 15, the operations further comprising:
determining, based on natural language processing of the listing data, that the second item is in the first category of items that is related to the first item.

17. The machine-readable medium of claim 15, wherein identifying the second listing posted to the online marketplace comprises:
identifying a listing identifier for the second listing in the listing data included in the first listing.

18. The machine-readable medium of claim 15, wherein identifying the second listing posted to the online marketplace comprises:
identifying a uniform resource identifier (URL) for the second listing in the listing data included in the first listing.

19. The machine-readable medium of claim 15, wherein the first category of items that is related to the first item includes one of complimentary items, accessory items, and similar items.

20. The machine-readable medium of claim 15, the operations further comprising:
identifying, from the listing data included in the first listing, a fourth listing posted to the online marketplace, the fourth listing offering a third item for sale;
categorizing the third item in a second category of items that is related to the first item; and
generating a second item recommendation based on the second category of items that is related to the first item, the second item recommendation identifying a fifth listing offering the third item for sale.
